(19) United States
(12) Patent Application Publication
(10) Pub. No.: US 2006/0178829 A1
(43) Pub. Date: Aug. 10, 2006

(54) Global acoustic positioning system and device

(76) Inventor: Thierry Gaiffe, L'Etang La Ville (FR)

Correspondence Address: YOUNG & THOMPSON, 745 SOUTH 23RD STREET, 2ND FLOOR, ARLINGTON, VA, 22202, US

(21) Appl. No.: 10/546,243

(22) PCT Filed: Feb. 18, 2004
(86) PCT No.: PCT/FR04/50065

§ 371 Date: Aug. 19, 2005

(30) Foreign Application Priority Data
Aug. 19, 2005 (FR) 03/50028

(51) Int. Cl. G01C 21/00

(52) U.S. Cl. 701/213; 701/21

(57) ABSTRACT

A device for global acoustic positioning of submarine vessels (1) includes positioning elements for referencing geographically the device and a positioning acoustic signal transceiver (6). The acoustic signal transceiver (6) is an ultra short base line system (USBL) which generates n first position measurements, where n is the number of submarine vessels (1) measured simultaneously, n being greater than or equal to 1 and the device includes elements for restituting the movements of the device (10) delivering signals, real-time processing elements (11) receiving the set of measurements to determine the actual position of the submarine vessel(s) (1) and elements (12) for transmitting the actual position of the submarine vessel(s) (1) in and/or off water.

The present invention relates to a device and a system for global acoustic positioning of submarine vessels.

Several satellite navigation and positioning systems, known generally under the generic term of GPS for “Global positioning system” are operational (the American system “NAVSTAR” and its Russian equivalent “GLONASS”) or are being developed (the European project GALILEO). The GPS includes a spatial portion including a constellation of satellites placed in orbit around the Earth and transmitting electromagnetic signals, a ground control section, composed of stations for tracking and controlling such satellites, and a military or civilian user section. From the electromagnetic signals transmitted, the absolute position of any receiver, placed at or near the earth surface may be determined with a precision of the order of 10 to 15 metres for civilian usage. The receiver uses therefore the data transmitted by four satellites placed on different orbits and hence at different distances. The first three satellites enable rough determination of the position comprising errors due to the offset between the clock of each of the satellites and the user's, the fourth one gives the real transmission instant of the signals. The GPS has proven the ideal real-time navigation system to equip the ships and the vehicles because of its low cost of its receiver and its simplicity of usage by day as well as by night.

However, the radio waves transmitted by the satellites do not propagate in the marine media where they are absorbed very rapidly. As the positioning of submarine receivers by GPS is not possible, other submarine navigation and positioning systems have been developed. The main common salient feature of these technologies is the implementation of acoustic waves.

For example, a long base line system (LBL) is known, which uses at least three acoustic beacons arranged on the sea floor. The submarine receiver receives the acoustic signals from said beacons and determines its position according to the principle of triangulation. Knowing the sound propagation speed in the sea, the measurement of the time taken by the signal transmitted by each of the buoys gives the relative distance of said device with respect to each of the buoys. However, this system remains complex because of the difficulty and the cost of installation of the beacons on the sea floor.

YOUNGBERG J. W. describes in the U.S. Pat. No. 5,119,341 a method to extend the GPS to submarine applications and in particular, to provide a navigation system to stand-alone submarines. This system implements drifting buoys which, determining their position as any other GPS user, transmit them thanks to transducers to submarine vehicles seeking to determine their position. However, this system requires implementation of at least three drifting buoys so that the submarine vehicle may determine its position by triangulation while taking into account the possibility that signals from a buoy are not detected. Moreover, these buoys do not enable accurate positioning since the determination of the dynamic position of the submarine vehicle does not integrate the external factors (sea condition, wind, .) liable to influence the position of each of the buoys and which might be translated by roll, pitch, course and heave sensors.

Besides, submarine acoustic positioning systems are known, using an ultra short base line system (USBL) to position submarine vehicles or targets, fixed or mobile, having a transponder. This system involves only one transponder and a single acoustic antenna, of reduced surface and containing receiving members. An acoustic or electric interrogation is sent to the transponder which returns an acoustic response. This acoustic response is received by the receiving members of the antenna thus permitting the determination of the position of the transponder. The distance is calculated on the basis of the time elapsed between the transmission of the interrogation signal and the reception of the acoustic response signal and the directions are deduced from the measurement of the phase differences in the reception of the response signal by the different receiving members. However, the acoustic antenna, fixed or extending, requires the parallel usage of an attitude sensor and of a GPS to correct the movements of the surface antenna. The acoustic antenna is hence hardly transportable and involves the mobilisation of a ship. Moreover, the respective positions, on-board the ship, of the GPS antenna, of the attitude central unit and of the acoustic antenna of the USBL system relative to the mass centre of the ship are such that corrections to the dynamic position of the acoustic antenna are necessary while considering the leverages between the acoustic antenna and the GPS antenna on the one hand, and the acoustic antenna and the attitude central unit, on the other hand. In particular, the latter may prove very significant.

A first object of the present invention is to provide a global acoustic positioning device and method, simple in their design and in their implementation, economic, without any necessary calibration of said device, with very long submarine range, stand-alone, highly integrated and easily transportable to suit the user's wishes and liable of being in charge on his own of several targets simultaneously, for the determination of the position of submarine devices fitted with a transponder.

Another object of the present invention is the realisation of a Global acoustic positioning system (“GAPS”) enabling, in a given maritime zone, submarine devices to known their exact position.

To this effect, the invention relates to a device for global acoustic positioning of submarine vessels comprising positioning means for referencing geographically said device and a positioning acoustic signal transceiver. According to the invention,

said acoustic signal transceiver is an ultra short base line system (USBL) which generates n first position measurements, where n is the number of submarine vessels measured simultaneously, n being greater than or equal to 1,

said device includes:
means for restituting the movements of the device delivering signals containing at least one attitude measurement of said device in an inertial reference system,
real-time processing means receiving all the measurements to determine the actual position of the submarine vessel(s),
means for transmitting the actual position of the submarine vessel(s) in and/or off water,
   and in that the respective positions means for restituting the movements of the device and of the acoustic signal transceiver relative to the mass centre of said device are such that the leverage between said means of restitution and said transceiver is zero.

By “attitude measurement” is meant a measurement of the orientation of said device in an inertial reference system, described mathematically by variables which are the course, the roll and the pitch.

In different embodiments, the present invention also concerns the following characteristics which should be considered individually or according to all their technically possible combinations:

n is greater than or equal to 2,

n is equal to 6,

the means for restituting the movements of the device include an attitude central unit,

the means for restituting the movements of the device include an inertial navigation central unit,

the refresh frequency of the signals delivered by said means for restituting the movements of the device is greater than or equal to 10 Hz,

the device comprises a buoy,

the buoy is a drift buoy,

the buoy comprises self-propelling means,

the device comprises docking means,

the device comprises a radioelectric signal transceiver,

the device comprises wire-type signal transceiver,

the device comprises stand-alone power supply means,

the positioning means for referencing geographically said device comprise a GPS.

The invention also concerns global acoustic positioning system for submarine devices. According to the invention, said system comprises a set of acoustic positioning devices as described previously. Each of these positioning devices is placed at a point in a point grid defined by the repetition of a same elementary mesh cutting up a sea zone to be covered.

In different possible embodiments, the invention will be described more in detail with reference to the appended drawings wherein:

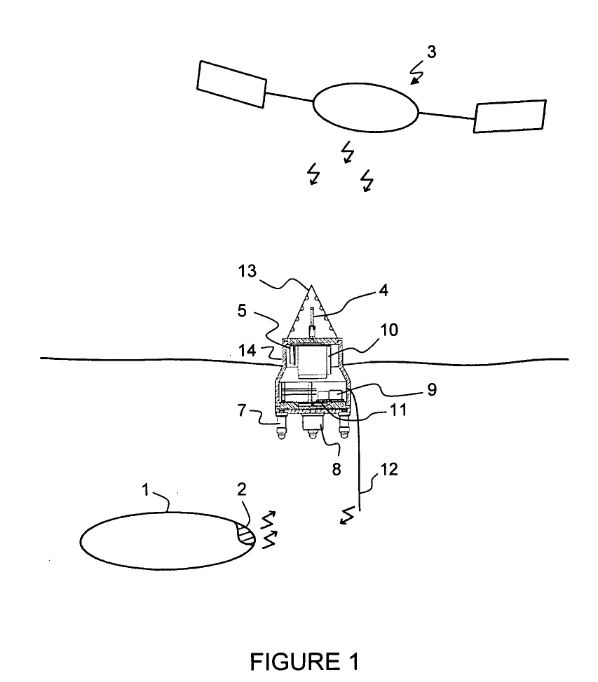

FIG. 1 is a schematic representation of a device for global acoustic positioning, according to an implementation embodiment of the invention;

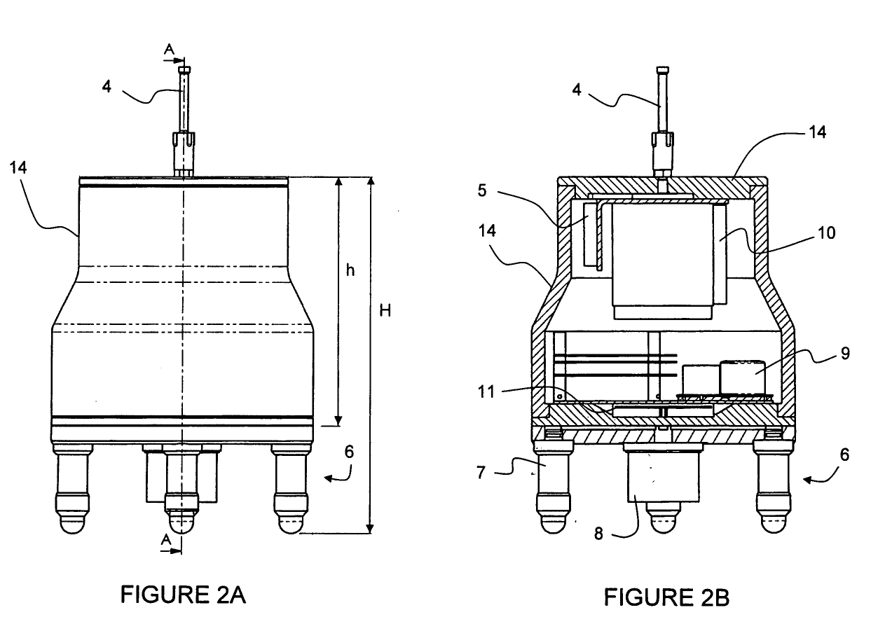

FIG. 2 is a schematic representation of a global acoustic positioning system, according to an embodiment of the invention. FIG. 2a) shows said system with its protective shroud and FIG. 2b) represents schematically a section along the axis A-A of said system.

The object of the invention is to determine with very great accuracy the dynamic position and the course of submarine vessels 1. By “submarine vessel” 1 is meant any vessel 1 fitted with at least one transponder 2 capable of communicating with the global acoustic positioning device (GAPS) of the invention and advantageously with a receiver for receiving its actual position as determined by the positioning device, said vessel being able to navigate underwater down to abyssal depths of 6000 m for example. Examples of such vessels are inhabited submarine vehicles, remote controlled or autonomous, portable and individual beacons, . . .

The device for global acoustic positioning of submarine vessels comprises positioning means for referencing geographically its position (FIG. 1). Such means may comprise for instance a GPS receiver receiving radioelectric signals transmitted by several satellites 3 from a GPS system, said receiver including a reception antenna 4 and an integrated calculator 5 determining accurately the absolute position of said device or a transceiver receiving signals transmitted from a terrestrial site or a ship fitted with a GPS, said signals giving a relative position of the device.

The device comprises an ultra short base line system (USBL) 6. This positioning acoustic signal transceiver 6 generates n first position measurements, where n is the number of submarine vessels 1 measured simultaneously by said positioning device with n greater than or equal to 1. Preferably, the device is capable of determining simultaneously the position of at least two submarine vessels 1. Advantageously, six submarine vessels 1 may be jointly processed in real time by the positioning acoustic device. As described above, the USBL-type acoustic signal transceiver USBL 6 comprises an antenna of reduced diameter, typically 300 mm containing four reception hydrophones 7 arranged, for instance perpendicular to one another, on the periphery of the antenna and a transmission transducer 8 placed in the centre of the antenna. The transmission transducer transmits acoustic interrogations at regular time intervals, typically at a frequency of the order of 16 kHz for a range of 6000 m and up to 40 kHz for a shorter range of 1000 m. When a submarine vessel 1 enters the coverage zone of the transducer, the transponder 2 wherewith it is fitted sends back an acoustic response if the latter 2 is placed in active localisation mode. Said acoustic response is received by the reception hydrophones 7 of the antenna thus permitting to determine the position of the transponder 2. Electronic means including a transmission supporting board 9 ensure control of the USBL system 6.

The global acoustic positioning device (GAPS) also comprises means for restituting the movements of the device 10 delivering signals containing at least one attitude measurement of said device in an inertial reference system (FIGS. 1 and 2b). These means of restitution 10 comprise either an attitude central unit, or an inertial navigation central unit. In the latter case, said central unit includes for instance 3 optic fibre gyroscopes, 3 accelerometers and calculation boards which advantageously enable to calculate the position and the maintenance of this position of the device when the constellation of GPS satellites is masked. Advantageously, the refresh frequency of the signals delivered by said means for restituting the movements of the device 10 is greater than or equal to 10 Hz. These signals are sent to processing means 11. Upon reception of said signals, the processing means 11 synchronise the acquisitions of the set of measurements. The three basic inputs of the device, obtained synchronously, hence correspond to the acquisition of a geographical localisation measurement of said positioning device, the signals generated by the means for restituting the movements of the device 10 and finally, the acquisitions of acoustic signals by the USBL system. The acoustic signals are for instance delivered by a Tx Rx board. The real-time processing means 11 determine upon reception of the set of these measurements the actual position of the submarine vessel(s) 1 present in the coverage zone or their relative position failing any absolute positioning means. Such processing means 11 take into account the variations in the sound propagation speed between the position of the device and that of the transponder 2 of the submarine vessel 1, said variations being due to variations in the salt content, the water temperature and the pressure.

The device comprises means for transmitting the actual position of the submarine vessel(s) 1 in and/or off water. In an embodiment, these means comprise a radioelectric signal transceiver. In another embodiment, they comprise a wire-type signal transceiver 12.

The positioning acoustic device may be implemented in different ways. It may be a box attached to a platform or a buoy for instance. This buoy may be a drifting buoy or have self-propelling means. In the latter case, the buoy may be guided or programmed for positioning at a precise geographic point for instance. This buoy may also have docking means and power supply means 13 to render said buoy autonomous.

The respective positions means for restituting the movements of the device 10 and of the acoustic signal transceiver 6 relative to the mass centre of said device are such that the leverage between said means of restitution 10 and said transceiver 6 is zero for the determination of the actual position of the submarine vessel 1. In case where the leverage is not negligible, it is calibrated during the manufacture of the positioning device and it is not necessary to take it into account at a later stage.

The invention also concerns a global acoustic positioning system for submarine vessels 1. This system comprises a set of acoustic positioning devices as described previously. Each of these positioning devices is placed at a given point of a sea zone to be covered. These points are defined by the repetition of a same elementary mesh thereby cutting up the sea zone into a point grid. Said point grid is hence defined as a regular arrangement of points in the plane of the surface of the sea zone, each point being connected to another in a direction given by the length of the elementary mesh and in a direction perpendicular thereto, by the width of said elementary mesh.

We shall now describe an embodiment of new and useful positioning acoustic devices according to the invention. FIG. 2 shows an embodiment example of the invention with a global acoustic positioning drifting buoy. FIG. 2a) shows said buoy without its floaters with its protective shroud 14, of stainless steel for instance. FIG. 2b) represents schematically a section along the axis A-A of said buoy. This buoy comprises an antenna 4 and a receiver GPS 5, means for restituting the movements of the device 10, an acoustic signal transceiver 6 which is a USBL system. This system comprises four reception hydrophones 7 and a transmission transducer 8 placed in the centre of the USBL system 6. Electronic means include a transmission supporting board 9 ensuring control of the USBL system 6. The typical dimensions of this buoy are a total height H of 400 mm, a USBL antenna diameter of 300 mm, a cover diameter of 240 mm and a height h of the protective shroud de 280 mm.

1. A device for global acoustic positioning of submarine vessels (1) comprising positioning means for referencing geographically said device and a positioning acoustic signal transceiver (6), characterised in that
said acoustic signal transceiver (6) is an ultra short base line system (USBL) which generates n first position measurements, where n is the number of submarine vessels (1) measured simultaneously, n being greater than or equal to 1,
said device includes:
means for restituting the movements of the device (10) delivering signals containing at least one attitude measurement of said device in an inertial reference system,
real-time processing means (11) receiving all the measurements to determine the actual position of the submarine vessel(s) (1),
means (12) for transmitting the actual position of the submarine vessel(s) (1) in and/or off water, and in that the respective positions of the means for restituting the movements of the device (10) and of the acoustic signal transceiver (6) relative to the mass centre of said device are such that the leverage between said means of restitution (10) and said transceiver (6) is zero.

2. A positioning device according to claim 1, characterised in that n is greater than or equal to 2.

3. A positioning device according to claim 2, characterised in that n is equal to 6.

4. A positioning device according to claim 1, characterised in that the means for restituting the movements of the device (10) include an attitude central unit.

5. A positioning device according to claim 1, characterised in that the means for restituting the movements of the device (10) include an inertial navigation central unit.

6. A positioning device according to claim 1, characterised in that the refresh frequency of the signals delivered by said means for restituting the movements of the device (10) is greater than or equal to 10 Hz.

7. A positioning device according to claim 1, characterised in that it comprises a buoy.

8. A positioning device according to claim 7, characterised in that the buoy is a drift buoy.

9. A positioning device according to claim 7, characterised in that the buoy comprises self-propelling means.

10. A positioning device according to claim 1, characterized in that it comprises docking means.

11. A positioning device according to claim 1, characterised in that it comprises a radioelectric signal transceiver.

12. A positioning device according to claim 1, characterised in that it comprises wire-type signal transceiver.

13. A positioning device according to claim 1, characterised in that it comprises stand-alone power supply means (13).

14. A positioning device according to claim 1, characterised in that the positioning means for referencing geographically said device comprise a GPS (4, 5).

15. A global acoustic positioning system for submarine vessels (1) characterised in that it comprises a set of acoustic positioning devices according to claim 1, each of said devices being placed at a point in a point grid defined by the repetition of a same elementary mesh cutting up a sea zone to be covered.
